(19) United States
(12) Patent Application Publication
(10) Pub. No.: US 2010/0068532 A1
(43) Pub. Date: Mar. 18, 2010

(54) INTERLAYER WITH NONUNIFORM SOLAR ABSORBER

(76) Inventor: William Keith Fisher, Suffield, CT (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/211,064

(22) Filed: Sep. 15, 2008

(51) Int. Cl. B32B 9/00

(52) U.S. Cl. 428/426

(57) ABSTRACT

The present invention includes interlayers and multiple layer glazing panels comprising those interlayers, wherein the interlayers comprise an infrared absorbing agent that is dispersed in the interlayer in a nonuniform distribution. The nonuniform distribution of the infrared absorbing agent allows the interlayer to be used successfully in applications in which transmission of a minimal level of infrared radiation is desirable to allow for sensor communication through the glazing.

### FIELD OF THE INVENTION

The present invention is in the field of polymer interlayers and multiple layer glazing panels comprising infrared absorbing agents, and, more specifically, the present invention is in the field of polymer interlayers and multiple layer glazing panels comprising infrared absorbing agents that are intended for use in applications that require transmission of communication signals in the infrared range of the electromagnetic spectrum.

### BACKGROUND

Poly(vinyl butyral) (PVB) is commonly used in the manufacture of polymer layers that can be used as interlayers in light-transmitting laminates such as safety glass or polymeric laminates. Safety glass often refers to a transparent laminate comprising a poly(vinyl butyral) layer disposed between two sheets of glass. Safety glass often is used to provide a transparent barrier in architectural and automotive openings. Its main function is to absorb energy, such as that caused by a blow from an object, without allowing penetration through the opening or the dispersion of shards of glass, thus minimizing damage or injury to the objects or persons within an enclosed area. Safety glass also can be used to provide other beneficial effects, such as to attenuate acoustic noise, reduce UV and/or IR light transmission, and/or enhance the appearance and aesthetic appeal of window openings.

In many applications it is desirable to use safety glass that not only has the proper physical performance characteristics for the chosen application, but that also has light transmission characteristics that are particularly suitable to the end use of the product. For example, it will often be desirable to limit infrared radiation transmission through laminated safety glass in order to provide improved thermal properties.

The ability to reduce transmission of infrared radiation, and specifically near infrared radiation, can be a particularly desirable characteristic of multiple layer glazing panels, and particularly for safety glass that is used in automotive and architectural applications. Reducing the transmission of infrared radiation can result in the reduction of heat generated by such radiation within an enclosed space.

Unfortunately, blocking infrared radiation also can have the effect of blocking desirable signals that need to be sent through glazing. For example, many modern automobiles have rain sensors that require transmission of infrared radiation through the windshield. Those transmissions can be attenuated or blocked by infrared absorption agents located in the interlayer or infrared reflective layers applied to the glass or a rigid substrate.

Further improved compositions and methods are needed to enhance the characteristics of multiple layer glazing panels comprising infrared absorbing agents to improve transmission of desirable signals without also detrimentally affecting heat rejection qualities.

### SUMMARY OF THE INVENTION

The present invention includes interlayers and multiple layer glazing panels comprising those interlayers, wherein the interlayers comprise an infrared absorbing agent that is dispersed in the interlayer in a nonuniform distribution. The nonuniform distribution of the infrared absorbing agent allows the interlayer to be used successfully in applications in which transmission of a minimal level of infrared radiation is desirable to allow for sensor communication through the glazing.

### BRIEF DESCRIPTION OF THE FIGURES

FIG. 1 is a schematic representation of one embodiment of the present invention.

FIG. 2 is a schematic representation of one embodiment of the present invention.

FIG. 3 is a schematic representation of one embodiment of the present invention.

FIG. 4 is a graph showing a transmission spectrum of an embodiment of the present invention.

FIG. 5 is a graph showing a transmission spectrum of an embodiment of the present invention.

### DETAILED DESCRIPTION

The present invention involves interlayers that utilize infrared absorbing agents and multiple layer glazing panels comprising those interlayers.

As used herein, a “multiple layer glazing interlayer” means an interlayer that can be used in a glazing having more than one layer, for example, two panes of glass with an interlayer therebetween. Interlayers can consist of a single polymer layer or multiple layers combined. Glazing panels can be used, for example, in automotive windshields and architectural applications.

As disclosed herein, interlayers of the present invention incorporate an infrared radiation absorbing agent that is distributed in a nonuniform manner within the interlayer. As used herein, an infrared absorbing agent in an interlayer is said to be distributed “nonuniformly” if the concentration of the agent across the height and width of an interlayer is not constant within a range of ±10% on a weight percent basis as measured as described below, as it is in conventional interlayers that employ infrared absorbing agents that are added to a melt and mixed to homogeneity prior to extrusion of a polymer layer.

Nonuniformity or uniformity of an infrared absorbing agent in an interlayer is ascertained by dividing the interlayer into 100 equal pieces by dividing both the long edge and the short edge into 10 equal columns and rows, respectively. The weight percent of infrared absorbing agent in each piece is then calculated. Each piece is then paired, in turn, with every other piece, and the differences in weight percent of infrared absorbing agent between the members of each pair are calculated and are called pair differences.

Each pair difference is then compared to the weight percent of infrared absorbing agent of each member of the pair, and if the pair difference for the pair is more than 5% greater than the weight percent of infrared absorbing agent of the member of the pair having the smaller weight percent of infrared absorbing agent, then that pair is said to be nonuniform. If more than 10% of all possible pairs are nonuniform, then the interlayer is, as defined herein, said to have a “nonuniform” distribution of infrared absorbing agent.

The “degree of nonuniformity” of the distribution of infrared absorbing agent in an interlayer can be measured, as described above, by calculating the total percentage of all possible pairs that are nonuniform. In various embodiments of the present invention, an interlayer has a distribution of infrared absorbing agent with a degree of nonuniformity, as measured above, of at least 10%, 20%, or 30%.

Nonuniform distributions of infrared absorbing agent can occur in any suitable pattern, and include, for example and without limitation, interlayers having a slowly changing gradient of infrared absorbing agent, interlayers having regions entirely devoid of infrared absorbing agent, and interlayers with random or repeating regions having no infrared absorbing agent or substantially less than the surrounding interlayer. In one embodiment, for example, the top portion of an interlayer that corresponds to the conventional location of a color band has a reduced amount of infrared absorbing agent. In another embodiment, a region of the interlayer close to the dash area of a vehicle has substantially less infrared absorbing agent than the rest of the interlayer. In yet further embodiments, interlayers have multiple, discrete regions that have substantially less infrared absorbing agent than the rest of the interlayer.

The infrared region of the electromagnetic spectrum lies in the wavelength region between 750 nanometers and 1 millimeter. It is divided into three regions: the near infrared (NIR) from 750 to 2,500 nanometers; the mid-infrared (MIR) from 2,500 nanometers to 10 microns; and, the far infrared from 10 microns to 1 millimeter. About half of the radiation from the sun lies in the NIR.

The infrared absorbing agents of the present invention absorb a significant amount of NIR energy, thereby reducing heat load but allowing transmission of visible light. Interlayers of the present invention having a nonuniform distribution of infrared absorbing agent will allow a measurable amount of infrared radiation to be transmitted.

Previous art attempts to provide a functional interlayer that has both the desired infrared transparency and heat blocking qualities include U.S. Pat. No. 6,620,477 to Nagai. Nagai provides an example in FIG. 6, which, unfortunately, shows little, if any, difference in infrared radiation transmission in the range of 850 to 900 nanometers, which is the critically preferred range in which signals are generated. Accordingly, that example interlayer would either transmit an undesirable amount of total infrared radiation, or would excessively block the infrared signals sent by vehicle peripherals.

The interlayers of the present invention with a nonuniform distribution of infrared absorbing agent solve that problem by providing two or more regions with an interlayer having a substantial difference in transmission at 880 nanometers.

In one embodiment of the present invention, an interlayer has two regions, wherein the first region allows a transmission at 880 nanometers of at least 15% and the second region allows a transmission at 880 nanometers of less than 10%. In other embodiments, the first region allows a transmission at 880 nanometers of at least 72% and the second region allows a transmission at 880 nanometers of less than 23%.

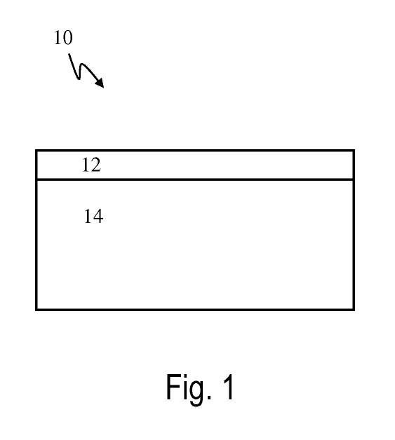

Examples of interlayers having a first region and a second region are shown in FIGS. 1, 2, and 3. As shown in FIG. 1 generally at 10, two regions can be formed wherein a first region 12 has low or zero levels of infrared absorbing agent and a second region 14 incorporates a level of infrared absorbing agent sufficient to block infrared radiation as described elsewhere herein.

In the embodiment shown in FIG. 1, the first region, which lacks or substantially lacks infrared absorbing agent, is located in the color band region (gradient region) of the interlayer in a windshield. The color band region can have a height, for example, of 10% of the height of the interlayer or less, 8% of the height or less, or 5% of the height of the interlayer or less.

A region having a low or zero concentration of infrared absorber can be made by using a coextrusion process where there is a main melt stream and a secondary melt stream. The secondary melt stream contains a low or zero concentration of infrared absorber, whereas the main melt stream has a high concentration of infrared absorbing agent. The region of low or zero concentration of infrared absorber can be created by inserting a probe into the main melt stream through which the second melt stream is extruded and combined with the main melt stream just before extrusion into sheet. The size of the low concentration zone can be controlled by the depth of penetration of the probe into the main melt stream and the size of the probe, for example, and the melt injected by the probe can form a region that ranges in thickness from a portion of the total thickness of the interlayer to the total thickness of the interlayer.

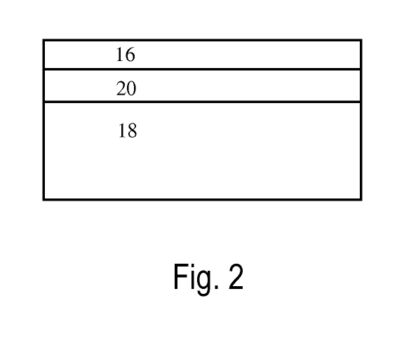

FIG. 2 shows an alternative embodiment in which a first region 20 having low or zero levels of infrared absorbing agent is formed as a band between a second region 16 and third region 18 having a level of infrared absorbing agent sufficient to block infrared radiation as described elsewhere herein. Typically the second and third region will be formed from the same melt, and will therefore have the same concentration of infrared absorbing agent, but the present invention includes other embodiments in which the second region 16 and the third 18 region have different concentrations of infrared absorbing agent. The first region 20 in this embodiment can have any of the shapes and sizes given for the first region 12 in FIG. 1, and the second region 16 in FIG. 2 can have a height that is any suitable proportion of the entire height of the interlayer—for example, 10% of the height or less, 8% of the height or less, or 5% of the height of the interlayer or less.

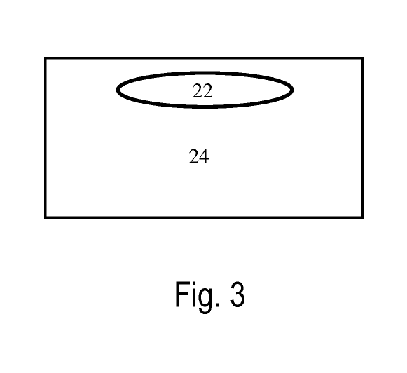

FIG. 3 represents a schematic illustration of a further embodiment of the present invention in which a first region 22 having low or zero levels of infrared absorbing agent is formed within a surrounding second region 24 that incorporates a level of infrared absorbing agent sufficient to block infrared radiation as described elsewhere herein. An interlayer according to this embodiment can be formed, for example, by utilizing a coextruding system in which a first polymer melt having the infrared absorbing agent is extruded normally and a second polymer melt having little or no infrared absorbing agent is extruded in intermittent pulses in an extrusion stream within the first polymer melt. Alternately a cut-out in an interlayer can be formed, and an appropriately sized piece of interlayer containing no or a reduced amount of infrared absorbing agent could be inserted into the cut-out area. This embodiment allows for targeted placement of the infrared transmitting portion of a finished windshield, which allows for maximum infrared radiation blocking throughout most of the windshield and maximum transmission in a limited location in which a sensor is transmitting.

Interlayers of the present invention can comprise a single polymer layer, or multiple polymer layers that are in bound in contact with each other and which together form a multiple layer interlayer. In either case, one or more layers of the interlayer can have an infrared absorbing agent.

Exemplary multiple layer interlayer constructs include the following:
(polymer layer)ₙ
(polymer layer/polymer film/polymer layer)ₚ

where n is 1 to 10 and, in various embodiments, is less than 5, and p is 1 to 5, and, in various embodiments, is less than 3.

Interlayers of the present invention can be incorporated into multiple layer glazing panels, and, in various embodiments, are incorporated between two layers of glass. Applications for such constructs include automobile windshields and architectural glass, among others.

In other embodiments of the present invention, interlayers comprising infrared absorbing agents are used in bilayers. As used herein, a bilayer is a multiple layer construct having a rigid substrate, such as glass or acrylic, with an interlayer disposed thereon. A typical bilayer construct is: (glass)//(polymer layer)//(polymer film)

Bilayer constructs include, for example and without limitation:
(Glass)//((polymer layer)ₕ//(polymer film))_{g}
(Glass)//(polymer layer)ₕ//(polymer film)

where h is 1 to 10, and, in various embodiments is less than 3, and g is 1 to 5, and, in various embodiments, is less than 3.

In further embodiment, interlayers as just described can be added to one side of a multiple layer glazing panel to act as a spall shield, for example and without limitation:
(Multiple Layer Glazing panel)//((polymer layer)ₕ//(polymer film))_{g}
(Multiple Layer Glazing panel)//(polymer layer)ₕ//(polymer film)

where h is 1 to 10, and, in various embodiments is less than 3, and g is 1 to 5, and, in various embodiments, is less than 3.

In various embodiments, solar control glass (solar glass) is used for one or more multiple layer glass panels of the present invention. Solar glass can be any conventional glass that incorporates one or more additives to improve the optical qualities of the glass, and specifically, solar glass will typically be formulated to reduce or eliminate the transmission of undesirable wavelengths of radiation, such as near infrared and ultraviolet. Solar glass can also be tinted, which results in, for some applications, a desirable reduction of transmission of visible light. Examples of solar glass that are useful in the present invention are bronze glass, gray glass, low E (low emissivity) glass, and solar glass panels as are known in the art, including those disclosed in U.S. Pat. Nos. 6,737,159 and 6,620,872. As will be described below, rigid substrates other than glass can be used.

In various embodiments of the present invention, infrared absorbing agents of the present invention are disbursed on or within a polymer layer and/or a polymer film. Generally, agent levels will be sufficient to impart the desired infrared absorbance on the layer, depending on the application.

Infrared absorbing agents of the present invention include those known in the art. Examples include, without limitation, antimony doped tin oxide (ATO), tin doped indium oxide (ITO), tungsten bronzes containing alkali or alkali earth metals, lanthanum hexaboride, oxides, nitrides, oxynitrides and sulfides of Sn, Ti, Si, Zn, Zr, Fe, Al, Cr, Co, Ce, In, Ni, Ag, Cu, Pt, Mn, T, W, V, or Mo, classes of organic infrared absorbing agents such as phthalocyanine, croconium, cyanine, Ni dithiolene, Sb aminium, Pd aminium, squarylium, and quaterrylene. Preferred agents include tungsten oxide doped with cesium and lanthanum hexaboride.

In various embodiments of the present invention the preferred agent is lanthanum hexaboride. The preparation of lanthanum hexaboride and its incorporation into or onto polymeric substrates is well known in the art (see, for example, U.S. Pat. Nos. 6,620,872 and 6,911,254). Lanthanum hexaboride is available, for example, as a dispersion of solid particles in liquid, with zirconium and dispersion agents included as appropriate.

Lanthanum hexaboride can be incorporated into polymer layers of the present invention in any suitable amount, and will generally be incorporated in an amount that is sufficient to provide the desired near infrared absorbance without also excessively impacting optical performance. In various embodiments, lanthanum hexaboride is incorporated into polymer layers in amounts of 0.005 to 0.1 weight percent, 0.01 to 0.05 weight percent, or 0.01 to 0.04 weight percent. In embodiments in which other infrared absorbers are used, the amount of lanthanum hexaboride can be reduced appropriately. Examples of other useful infrared absorbers include indium tin oxide and doped tin oxide, among others.

Lanthanum hexaboride that is useful in the present invention can be nano-sized, ground particles, for example, less than 250 nanometers, less than 200 nanometers, less than 150 nanometers, or less than 100 nanometers in size.

Cesium tungsten oxide that is useful in the present invention can be nano-sized, ground particles, for example, less than 250 nanometers, less than 200 nanometers, less than 150 nanometers, or less than 100 nanometers in size.

### Polymer Film

As used herein, a “polymer film” means a relatively thin and rigid polymer layer that functions as a performance enhancing layer. Polymer films differ from polymer layers, as used herein, in that polymer films do not themselves provide the necessary penetration resistance and glass retention properties to a multiple layer glazing structure, but rather provide performance improvements, such as infrared absorption character. Poly(ethylene terephthalate) is most commonly used as a polymer film.

In various embodiments, the polymer film layer has a thickness of 0.013 mm to 0.20 mm, preferably 0.025 mm to 0.1 mm, or 0.04 to 0.06 mm. The polymer film layer can optionally be surface treated or coated to improve one or more properties, such as adhesion, infrared radiation absorption and/or reflection. These functional performance layers include, for example, a multi-layer stack for reflecting infrared solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known, (see, for example, U.S. Pat. Nos. 4,017,661 and 4,786,783), the metal layer(s) may optionally be electrically resistance heated for defrosting or defogging of any associated glass layers.

An additional type of polymer film that can be used with the present invention, which is described in U.S. Pat. No. 6,797,396, comprises a multitude of nonmetallic layers that function to reflect infrared radiation without creating interference that can be caused by metallic layers.

The polymer film layer, in some embodiments, is optically transparent (i.e. objects adjacent one side of the layer can be comfortably seen by the eye of a particular observer looking through the layer from the other side), and usually has a greater, in some embodiments significantly greater, tensile modulus regardless of composition than that of any adjacent polymer layer. In various embodiments, the polymer film layer comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers, and the like. In various embodiments, the polymer film layer comprises materials such as re-stretched thermoplastic films having the noted properties, which include polyesters, for example poly(ethylene terephthalate) and poly(ethylene terephthalate) glycol (PETG). In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 minutes at 150° C.).

Various coating and surface treatment techniques for poly(ethylene terephthalate) film that can be used with the present invention are disclosed in published European Application No. 0157030. Polymer films of the present invention can also include a hardcoat and/or and antifog layer, as are known in the art.

In some embodiments of the present invention, a polymer film layer is included in a multiple layer interlayer having one or more polymer layers in addition to the polymer film layer. In these embodiments, the polymer film can have infrared absorbing agents distributed nonuniformly, either in addition to or in place of one or more polymer layers. In these embodiments, the distribution of the infrared absorbing agent in or on the polymer film can be any of those given elsewhere for polymer layers.

### Polymer Layer

The following section describes the various materials, such as poly(vinyl butyral), that can be used to form polymer layers of the present invention.

As used herein, a “polymer layer” means any thermoplastic polymer composition formed by any suitable method into a thin layer that is suitable alone, or in stacks of more than one layer, for use as an interlayer that provides adequate penetration resistance and glass retention properties to laminated glazing panels. Plasticized poly(vinyl butyral) is most commonly used to form polymer layers.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, such as acetates, salts, and alcohols. As used herein, “melt” refers to a melted mixture of resin with a plasticizer and, optionally, other additives.

The polymer layers of the present invention can comprise any suitable polymer, and, in a preferred embodiment, as exemplified above, the polymer layer comprises poly(vinyl butyral). In any of the embodiments of the present invention given herein that comprise poly(vinyl butyral) as the polymeric component of the polymer layer, another embodiment is included in which the polymer component consists of or consists essentially of poly(vinyl butyral). In these embodiments, any of the variations in additives, including plasticizers, disclosed herein can be used with the polymer layer having a polymer consisting of or consisting essentially of poly(vinyl butyral).

In one embodiment, the polymer layer comprises a polymer based on partially acetalized poly(vinyl alcohol)s. In another embodiment, the polymer layer comprises a polymer selected from the group consisting of poly(vinyl butyral), polyurethane, poly(vinyl chloride), poly(ethylene vinyl acetate), combinations thereof, and the like. In further embodiments the polymer layer comprises poly(vinyl butyral) and one or more other polymers. Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful components in polymer layers.

For embodiments comprising poly(vinyl butyral), the poly(vinyl butyral) can be produced by known acetalization processes, as are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

In various embodiments, the polymer layer resin comprising poly(vinyl butyral) comprises 10 to 35 weight percent (wt. %) hydroxyl groups calculated as poly(vinyl alcohol), 13 to 30 wt. % hydroxyl groups calculated as poly(vinyl alcohol), or 15 to 22 wt. % hydroxyl groups calculated as poly(vinyl alcohol). The polymer layer resin can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, for example, a 2-ethyl hexanal group (see, for example, U.S. Pat. No. 5,137,954).

In various embodiments, the polymer layer comprises poly(vinyl butyral) having a molecular weight at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalization step to increase molecular weight to at least 350,000 g/mole (see, for example, U.S. Pat. Nos. 4,902,464; 4,874,814; 4,814,529; and, 4,654,179). As used herein, the term “molecular weight” means the weight average molecular weight.

Various adhesion control agents can be used in polymer layers of the present invention, including sodium acetate, potassium acetate, and magnesium salts. Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate)(chemical abstracts number 79992-76-0). In various embodiments of the present invention the magnesium salt is magnesium bis(2-ethyl butyrate). Because epoxy agents tend to increase the adhesiveness of a polymer layer, relatively greater amounts of adhesion control agents will generally be used in interlayers of the present invention.

Other additives may be incorporated into the polymer layer to enhance its performance in a final product. Such additives include, but are not limited to, dyes, pigments, stabilizers (e.g., ultraviolet stabilizers), antioxidants, antiblock agents, additional IR absorbers, flame retardants, combinations of the foregoing additives, and the like, as are known in the art.

In various embodiments of polymer layers of the present invention, the polymer layers can comprise 20 to 60, 25 to 60, 20 to 80, 10 to 70, or 10 to 100 parts plasticizer phr. Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) layer. In general, higher amounts of plasticizer are added to decrease the T_{g}. Poly(vinyl butyral) polymer layers of the present invention can have a T_{g} of 40° C. or less, 35° C. or less, 30° C. or less, 25° C. or less, 20° C. or less, and 15° C. or less.

Any suitable plasticizers can be added to the polymer resins of the present invention in order to form the polymer layers. Plasticizers used in the polymer layers of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, mixtures of phosphates and adipates such as disclosed in U.S. Pat. No. 3,841,890, adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779, and C₆ to C₈ adipate esters, such as hexyl adipate. In various embodiments, the plasticizer used is dihexyl adipate and/or triethylene glycol di-2 ethylhexanoate.

The poly(vinyl butyral) polymer, plasticizer, and any additives can be thermally processed and configured into sheet form according to methods known to those of ordinary skill in the art. One exemplary method of forming a poly(vinyl butyral) sheet comprises extruding molten poly(vinyl butyral) comprising resin, plasticizer, and additives by forcing the melt through a die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet. In various embodiments, the polymer layers can have thicknesses of, for example, 0.1 to 2.5 millimeters, 0.2 to 2.0 millimeters, 0.25 to 1.75 millimeters, and 0.3 to 1.5 millimeters.

For each embodiment described above comprising a glass layer, another embodiment exists, where suitable, wherein a non-glass glazing type material is used in place of the glass. Examples of such glazing layers include rigid plastics having a high glass transition temperature, for example above 60° C. or 70° C., for example polycarbonates and polyalkyl methacrylates, and specifically those having from 1 to 3 carbon atoms in the alkyl moiety.

Also included in the present invention are stacks or rolls of any of the polymer layers and interlayers of the present invention disclosed herein in any combination.

The present invention also includes windshields, windows, and other finished glazing products comprising any of the interlayers of the present invention.

The present invention includes methods of manufacturing interlayers and glazing panels comprising forming an interlayer or glazing panel of the present invention using any of the polymer layers of the present invention described herein.

Also included herein within the scope of the present invention are methods of reducing transmission of infrared and/or near infrared radiation through an opening, comprising the step of disposing in said opening any of the polymer layer constructs of the present invention, for example, within a windshield or glazing panel.

In various embodiments of the present invention, two or more polymer layers are formed into an interlayer through coextrusion, which is a process in which two or more polymer melts are extruded at the same time to form a multiple layer interlayer with two or more adjacent polymer layers in contact with each other without the need for a later lamination step. For each interlayer embodiment of the present invention in which two or more separate polymer layers are disposed in contact with one another and subsequently laminated into a single interlayer, there also exists an embodiment where a coextruded interlayer is formed to have the same layer arrangement, which, as used herein, is considered to be formed of individual polymer layers and is considered a “multiple layer” interlayer.

### EXAMPLES

### Example 1

A dispersion of Cs_{0.33}WO₃ (CWO) nanoparticle in triethylene glycol di-(2-ethylhexanoate) is diluted and mixed with triethylene glycol di-(2-ethylhexanoate), blended with polyvinyl butyrate resin, and extruded to form a 0.76 millimeter thick sheet with a gradient band approximately 29.21 centimeters (11.5″) wide along one edge of the sheet. The CWO dispersion is added to yield 0.06% CWO nanoparticles in the non-gradient band region of the sheet. The gradient band contained 0% CWO and is formed using a second melt stream and a coextrusion probe that extends into the main melt stream.

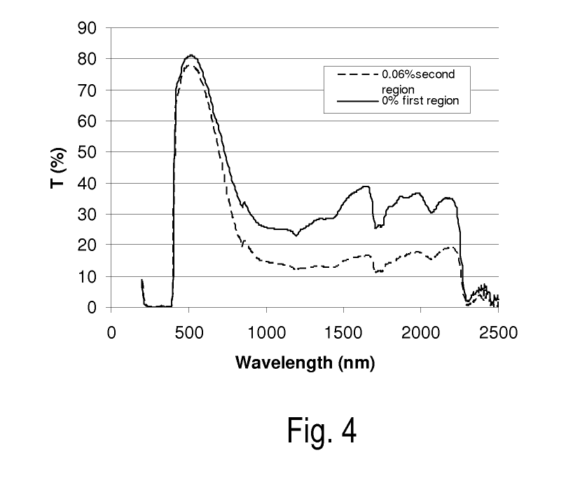

This interlayer is laminated between a layer of clear glass and a layer of tinted glass. The resulting laminate has a visible transmittance of 74.0% in the non-gradient region and 77.8% in the gradient band. The transmission at 880 nanometers in the non-gradient region is 19.6% and 38.6% in the gradient region. The transmission spectra are shown in FIG. 4.

### Example 2

An interlayer is formed as in Example 1 with 0.14% CWO in the non-gradient region and 0.06% CWO in the gradient portion. The visible transmission in the vision portion of the laminate is 73.4% and 80.1% in the gradient portion. The transmission at 880 nanometers in the vision portion is 13.1% and the transmission at 880 nanometers in the gradient portion is 28.6%.

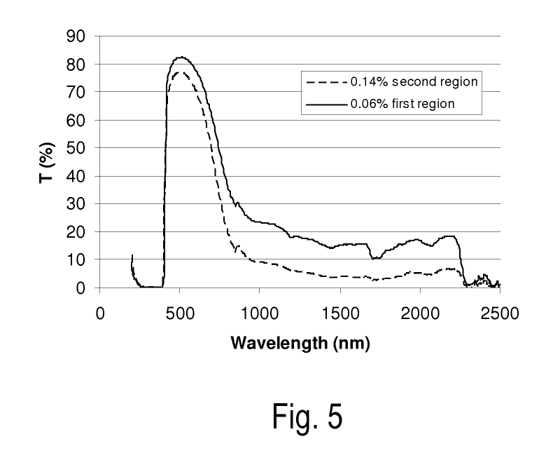

The transmission spectra are shown in FIG. 5.

By virtue of the present invention, it is now possible to provide interlayers, such as a poly(vinyl butyral) layer, having a nonuniform distribution of infrared absorbing agent that allows for the transmission of desirable infrared signals.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, and that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer layer can be formed comprising cesium tungsten oxide in any of the ranges given in addition to having a nonuniform distribution in any of the patterns given, where appropriate, to form many permutations that are within the scope of the present invention, but that would be cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

We claim:

1. A multiple layer glazing interlayer, comprising:
an infrared absorbing agent, wherein the distribution of said infrared absorbing agent in said interlayer has a degree of nonuniformity of greater than 10%.

2. The interlayer of claim 1, wherein said degree of nonuniformity is greater than 20%.

3. The interlayer of claim 1, wherein said interlayer comprises a first region and a second region, wherein said first region allows at least 15% transmission of infrared radiation at 880 nanometers and said second region allows less than 10% transmission of infrared radiation at 880 nanometers.

4. The interlayer of claim 3, wherein said first region allows at least 72% transmission of infrared radiation at 880 nanometers and said second region allows less than 23% transmission of infrared radiation at 880 nanometers.

5. The interlayer of claim 4, wherein said first region is a gradient region.

6. The interlayer of claim 4, wherein said first region is located within said second region.

7. The interlayer of claim 1, wherein said infrared absorbing agent is LaB₆ or cesium tungsten oxide.

8. The interlayer of claim 1, wherein said degree of nonuniformity is greater than 30%.

9. The interlayer of claim 1, wherein said infrared absorbing agent is cesium tungsten oxide.

10. A multiple layer glazing comprising:
a multiple layer glazing interlayer, comprising:
an infrared absorbing agent, wherein the distribution of said infrared absorbing agent in said interlayer has a degree of nonuniformity of greater than 10%.

11. The interlayer of claim 10, wherein said degree of nonuniformity is greater than 20%.

12. The interlayer of claim 10, wherein said interlayer comprises a first region and a second region, wherein said first region allows at least 15% transmission of infrared radiation at 880 nanometers and said second region allows less than 10% transmission of infrared radiation at 880 nanometers.

13. The interlayer of claim 12, wherein said first region allows at least 72% transmission of infrared radiation at 880 nanometers and said second region allows less than 23% transmission of infrared radiation at 880 nanometers.

14. The interlayer of claim 13, wherein said first region is a gradient region.

15. The interlayer of claim 13, wherein said first region is located within said second region.

16. The interlayer of claim 10, wherein said infrared absorbing agent is LaB₆ or cesium tungsten oxide.

17. The interlayer of claim 10, wherein said degree of nonuniformity is greater than 30%.

18. The interlayer of claim 10, wherein said infrared absorbing agent is cesium tungsten oxide.
